(19) United States
(12) Patent Application Publication
(10) Pub. No.: US 2011/0242827 A1
(43) Pub. Date: Oct. 6, 2011

(54) REMOVABLE MOUNTING SYSTEM

(75) Inventors: John FARINOLA, Monroe Township, NJ (US); Charles Babboni, Roseland, NJ (US)

(73) Assignee: Trinity, LLC, Metuchen, NJ (US)

(21) Appl. No.: 12/899,289

(22) Filed: Oct. 6, 2010

Related U.S. Application Data
(60) Provisional application No. 61/249,065, filed on Oct. 6, 2009.

(51) Int. Cl. F21V 15/01; A47F 5/00

(52) U.S. Cl. 362/368; 248/200.1

(57) ABSTRACT

A removable mounting system is provided and configured to be removably mounted between shelves. The removable mounting system has a housing member with a linkage passage extending in a longitudinal direction and opening at an end portion of the housing member. The removable mounting system also has a linkage member. The linkage member includes a interconnecting portion pivotably mounted to the housing member, a mounting portion at least partially received in the linkage passage and movable in the longitudinal direction of the linkage passage, and a linkage portion pivotably connecting the interconnecting portion and the mounting portion of the linkage member. The linkage portion of the linkage member is movable between an engaged position and a released position of the linkage member. In the engaged position, the linkage portion is aligned with the interconnecting portion and the mounting portion of the linkage member so that the removable mounting system can be mounted in position. In the released position, the linkage portion pivots open to release the linkage member from the engaged position.

### CROSS-REFERENCE TO RELATED APPLICATION

This patent application claims priority from U.S. Provisional Patent Application Ser. No. 61/249,065 filed Oct. 6, 2010, the entire content of which is incorporated herein by reference.

### BACKGROUND OF THE INVENTION

1. Field of the Invention

The present invention relates generally to a removable mounting system capable of being removably mounted between surfaces. More specifically, the invention relates to a removable mounting system for mounting various fixture components between shelves without need of using mounting fasteners or mounting tools.

2. Description of the Related Art

Display shelves have been used to store and display articles. While the articles on the top shelf are readily visible under various conventional and/or ambient lighting, articles placed between shelves are often blocked from conventional and/or ambient lighting. Consequently, the display effect of these articles between shelves is largely compromised.

Undershelf lighting units have been used to address the above problem. These conventional undershelf lighting units however demand labor and skills when installing and removing such undershelf lighting units. In addition, various mounting tools are required during the installation and removal process. When the lightings are to be mounted between the shelves, the operation becomes even more difficult as the technician must manipulate the mounting tools in a limited space between the shelves.

The following description provides a mounting system to solve the above problems. More specifically, the following embodiments provide a removable mounting system capable of being removably mounted between shelves and/or mounting various fixture components between shelves without need of using mounting fasteners or mounting tools.

### SUMMARY OF THE INVENTION

The embodiments disclosed herein relate to a removable mounting system capable of being removably mounted between shelves. More specifically, the invention relates to a removable mounting system for mounting various fixture components between shelves without need of using mounting fasteners or mounting tools.

The removable mounting system comprises a housing member with a linkage passage extending in a longitudinal direction and opening at an end portion of the housing member. The removable mounting system also comprises a linkage member interconnected with the housing member. For example, the linkage member includes an interconnecting portion pivotably mounted to the housing member, a mounting portion configured to be at least partially received in the linkage passage and movable in the longitudinal direction of the linkage passage, and a linkage portion pivotably connecting the interconnecting portion and the mounting portion of the linkage member.

The linkage portion of the linkage member is movable between an engaged position and a released position of the linkage member. In the engaged position, the linkage portion of the linkage member is aligned with the interconnecting portion and the mounting portion of the linkage member so that the removable mounting system can be mounted in position. In the released position, the linkage portion of the linkage member pivots open to release the linkage member from the engaged position.

### BRIEF DESCRIPTION OF THE DRAWINGS

The following description is set forth in connection with the attached drawing figures, which are not necessarily to scale, emphasis instead generally being placed upon illustrating the principles of the invention. In the drawing figures:

FIG. 1 is an exploded perspective view of a removable mounting system;

FIG. 2 is a perspective view of the removable mounting system in a released position;

FIG. 3 is a perspective view of the removable mounting system in an engaged position;

FIG. 4 shows the removable mounting system in a first mounting position; and

FIG. 5 shows the removable mounting system in a second mounting position.

### DETAILED DESCRIPTION OF THE EMBODIMENTS

Various embodiments of the removable mounting system 1 are described below in connection with the drawing figures. In the following description of different embodiments, similar components and elements are designated with the numeral references and redundant description is omitted.

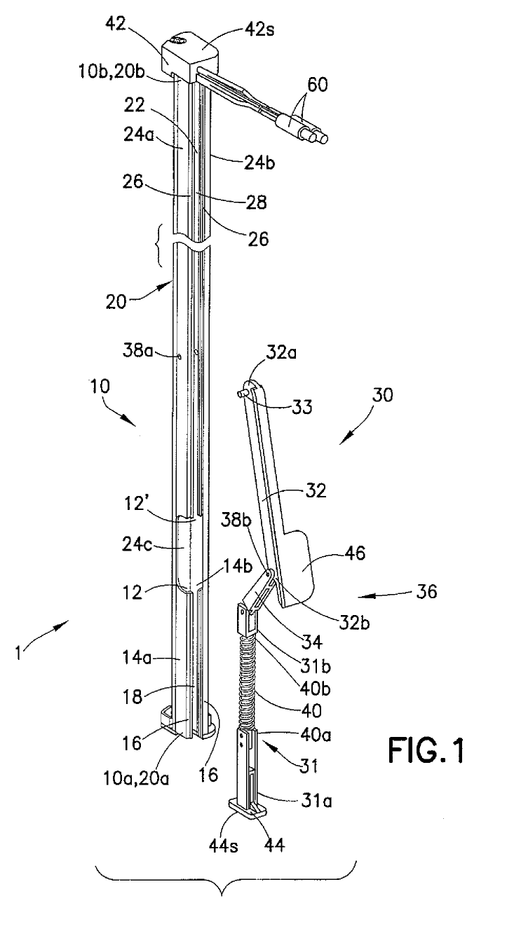

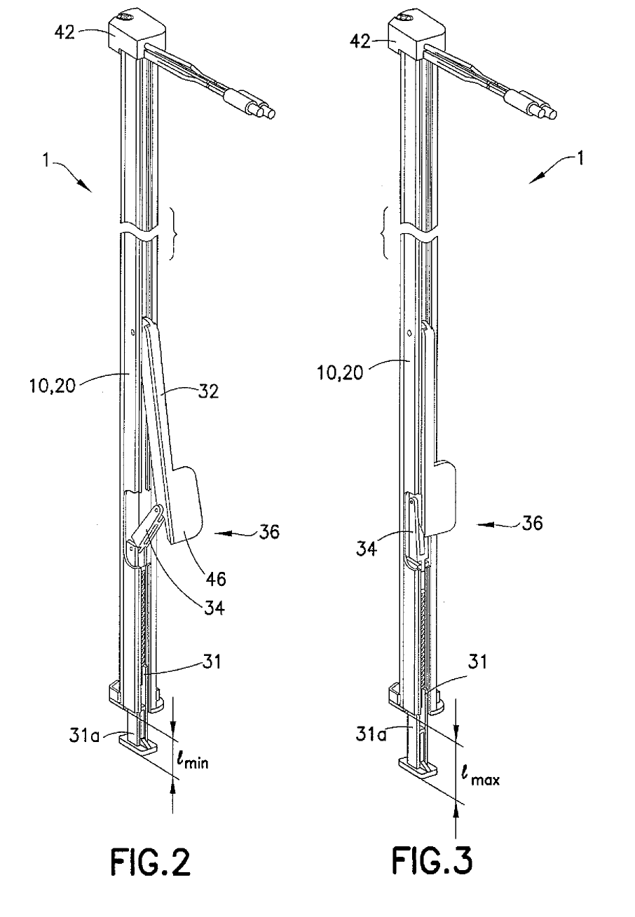

FIG. 1 shows a removable mounting system 1 formed according to various embodiments described below. The removable mounting system 1 is formed by interconnecting a housing member 10 with a linkage member 30 including pivotably connected portions. In the embodiment of FIG. 1, the housing member 10 includes a linkage passage 12 having a longitudinal direction and opening at an end portion 10a of the housing member 10. At least a part of the linkage member 30 can be received and accommodated in the linkage passage 12 in the housing member 10. For example, the linkage member 30 has a mounting portion 31 partially received inside the linkage passage 12 in the housing member 10. The mounting portion 31 of the linkage member 30 can be operated to slide between an extended position (see, e.g., FIG. 3) for mounting the removable mounting system 1 to a structure and a retracted position (see, e.g., FIG. 2) to release the removable mounting system 1. The linkage member 30 is configured to carry out such operation as will be described in greater detail below.

The housing member 10 of the removable mounting system 1 can be in various forms to interconnect with the linkage member 30 of the removable mounting system 1. As shown in FIG. 1, the housing member 10 includes longitudinal sidewalls 14a, 14b to define the linkage passage 12 in the housing member 10 to receive and support at least part of the mounting portion 31 of the linkage member 30. For example, the longitudinal sidewalls 14a, 14b of the housing member 10 extend parallel to each other in a longitudinal direction forming a linkage passage 12 with a U-shaped cross section.

The longitudinal sidewalls 14a, 14b of the housing member 10 can have lateral extensions 16 facing toward each other, as is shown in FIG. 1. The lateral extensions 16 narrow the longitudinal opening 18 of the linkage passage 12 between the longitudinal sidewalls 14a, 14b of the housing member 10. Accordingly, the lateral extensions 16 on the housing member 10 prevent the mounting portion 31 of the linkage member 30 from escaping from the longitudinal opening 18 of the linkage passage 12 in a transverse direction, thereby retaining the mounting portion 31 in the linkage passage 12 during the operation of the removable mounting system 1.

In one example as is shown in FIG. 1, the linkage passage 12 in the housing member 10 can extend for a sufficient length in the longitudinal direction to accommodate additional part of the linkage member 30 when the removable mounting system 1 is at the engaged position. For example, the linkage passage 12 can be extended in the longitudinal direction to an extended linkage passage 12′ for receiving and accommodating an interconnecting portion 32 of the linkage member 30 as will be described below.

In a preferred embodiment, the housing member 10 of the removable mounting system 1 is formed as an elongated structural member 20 extending in a longitudinal direction between two longitudinal ends 20a, 20b. As is illustrated by FIG. 1, the linkage passage 12, the elongated sidewalls 14a, 14b, the lateral extensions 16, and the longitudinal opening 18 of the housing member 10 extend along the elongated structural member 20, respectively, as elongated channel 22, elongated sidewalls 24a, 24b, elongated retaining portions 26, and longitudinal opening 28 of the elongated structural member 20.

For example, the elongated channel 22 is formed by the pair of elongated sidewalls 24a, 24b extending in the longitudinal direction of the elongated structural member 20. The linkage passage 12 can be formed as part of the elongated channel 22 at the longitudinal end 20a of the elongated structural member 20. Additionally or alternatively, the elongated structural member 20 can have a substantially uniform cross sectional shape. In one example, the elongated structural member 20 can have a U-shaped cross section formed by the elongated sidewalls 24a, 24b and rear wall 24c.

As FIG. 1 shows, the elongated sidewalls 24a, 24b of the elongated structural member 20 can comprise respective elongated retaining portions 26 facing toward each other in a transverse direction. The elongated retaining portions 26 narrow the longitudinal opening 28 of the elongated channel 22 between the elongated sidewalls 24a, 24b of the elongated structural member 20.

Additionally or alternatively, the elongated retaining portions 26 can limit lateral movement of the interconnecting portion 32 of linkage member 30 when the removable mounting system 1 is in the engaged position. In one example, the interconnecting portion 32 of the linkage member 30 is configured to be at least partially received in the elongated channel 22 and between the elongated retaining portions 26 at the engaged position. When the linkage member 30 is at the engaged position, the elongated retaining portions 26 limit a lateral movement of the interconnecting portion 32 of the linkage member 30.

In one example shown in FIG. 1, the elongated retaining portions 26 are discontinued where the linkage portion 34 of the linkage member 30 is located when the linkage member 30 is at the engaged position so that the linkage portion 34 can pivot between the extended position and the retracted position. In another example shown in FIG. 1, at least one of the elongated sidewalls 24a, 24b of the elongated structural member 20 is discontinued where the linkage portion 34 of the linkage member 30 is located when the removable mounting system 1 is in the engaged position.

As FIG. 1 shows, the linkage member 30 can have a toggle joint 36, which operates between the extended position and the retracted position and causes the outer end portion 31a of the mounting portion 31 to extend or retract. For example, the toggle joint 36 of the linkage member 30 can include an interconnecting portion 32 and a linkage portion 34, which operate the mounting portion 31 of the linkage member 30 to move inside the linkage passage 12 of the housing member 10. In another example, the linkage member 30 can be operated by hand, without using any tools. For example, the linkage member 30 of the removable mounting system 1 can comprise a manipulable projection member 46, such as in the form of a tab, configured to assist a user in changing the linkage member 30 between the extended position and the retracted position during the operation of the removable mounting system 1. In an example shown in FIG. 1, the projection member 46 is attached to the interconnecting portion 32 of the linkage member 30 and extends in a traverse direction of a plane in which the interconnecting portion 32 pivots. In another example, the projection member 46 can be attached to the linkage portion 34 of the linkage member 30.

The interconnecting portion 32 is pivotably mounted to the housing member 10. In the example shown in FIG. 1, the interconnecting portion 32 of the linkage member 30 has a first end 32a pivotably connected to the housing member 30 and a second end 32b pivotably connected with the linkage portion 34 of the linkage member 30. The interconnecting portion 32 of the linkage member 30 can pivot around the first end 32a to allow the second end 32b of the interconnecting portion 32 to move between the engaged position and a released position. In one example, one or both of the pivot connections 38a, 38b at respective first and second ends 32a, 32b of the interconnecting portion 32 can be realized through a pivot pin 33. Various other pivot connections can also be used to achieve the same purpose.

In the example shown in FIG. 1, the interconnecting portion 32 of the linkage member 30 is configured to be received in the extended linkage passage 12′ of the housing member 30 through longitudinal opening 18 when the removable mounting system 1 is in the engaged position. For example, the linkage passage 12 in the housing member 10 can extend continuously from the open end portion 10a of the housing member 10 to the first pivot connection 38a. When the linkage member 30 is in an extended position, the interconnecting portion 32 of the linkage member 30 the linkage member 30 pivots into the extended linkage passage 12′ of the housing member 10 and remains in the extended linkage passage 12′ until the linkage member 30 is retracted from the extended position.

The linkage portion 34 of the toggle joint 36 is movable between a released position and an engaged position of the linkage member 30 during the operation of the removable mounting system 1. In the released position, the linkage portion 34 of the linkage member 30 pivots open and withdraws the mounting portion 31 of the linkage member 30 further into the linkage passage 12. As a result, the mounting portion 31 of the linkage member 30 has a minimum length lₘᵢₙ extending outside the linkage passage 12 and beyond the open end portion 10a of the housing member 10, as is shown in FIG. 2. In the released position, the entire length of the removable mounting system 1 is reduced to allow the user to place the removable mounting system 1 in a mounting location determined by the user, or to discharge the removable mounting system 1 from the engaged position.

In the engaged position, the linkage portion 34 of the linkage member 30 is substantially aligned with the interconnecting portion 32 and the mounting portion 31 of the linkage member 30. In such a case, the outer end portion 31a of the mounting portion 31a extends outside the linkage passage 12 and beyond the open end portion 10a of the housing member 10 for a maximum length lₘₐₓ, as is shown in FIG. 3. Accordingly, the removable mounting system 1 expands in the longitudinal direction and can be mounted in position between two structural surfaces 110.

In a preferred embodiment, the toggle joint 36 of the linkage member 30 can be locked to prevent a retraction movement of the mounting portion 31 when the linkage member 30 is in the engaged position. In one example, the toggle joint 36 of the linkage member 30 pivots past an aligned position of the linkage member 30, where the multiple portions of the linkage member 30 extends in a linear direction. In the example shown in FIG. 3, when the linkage portion 34 of the linkage member 30 changes into its extended position, the pivot connection 38b of the interconnecting portion 32 and the linkage portion 34 can move past a center position, i.e., an imaginary aligned line extending through the mounting portion 31 of the linkage member 30. In such a case, the interconnecting portion 32 and the linkage portion 34 of the linkage member 30 are locked against unintended retraction movement of the linkage member 30.

To dislodge the toggle joint 36 of the linkage member 30 from the locked position describe above, the interconnecting portion 32 and the linkage portion 34 of the linkage member 30 are urged toward the imaginary aligned line extending through the mounting portion 31 of the linkage member 30. Such operation can be carried out by hand, without using additional mounting tools. When the interconnecting portion 32 and the linkage portion 34 of the linkage member 30 are urged to align with the imaginary aligned line extending through the mounting portion 31 of the linkage member 30, the toggle joint 36 of the linkage member 30 is released from the locked position. Continued pivot movement of the interconnecting portion 32 and the linkage portion 34 of the linkage member 30 will move the linkage member 30 into the released position as is described in the above embodiments.

In one example, the linkage portion 34 of the linkage member 30 can comprise a plurality of linkage sections pivotably connected to one another in series. One or more of such linkage sections can be arranged in the engaged position while the remaining linkage sections are arranged in a released position. In such an example, the extension and/or retraction of the mounting portion 31 of the linkage member 30 can move between the extended position and the retracted position in separate stages, during each of which only a different number of the linkage sections can be employed.

As stated above, the mounting portion 31 of the linkage member 30 is movable in the longitudinal direction of the linkage passage 12 and between the retracted position (see, e.g., FIG. 2) and the extended position (see, e.g., FIG. 3) during the operation of the removable mounting system 1. In one example, the mounting portion 31 of the linkage member 30 can be formed to have an outer end portion 31a configured to extend outside the linkage passage 12 in the housing member 10, as is shown in FIGS. 2 and 3. The outer end portion 31a on the mounting portion 31 is mounted to and supported on a supporting surface when the removable mounting system 1 is in the engaged position.

The mounting portion 31 of the linkage member 30 can be in various forms. In one example, the mounting portion 31 of the linkage member 30 comprises a compressible member 40 operable in the longitudinal direction of the linkage passage 12 of the housing member 10. The compressible member 40 of the mounting portion 31 is operable in the longitudinal direction of the linkage passage of the housing member. For example, the compressible member 40 of the mounting portion 31 can be compressed to retract the outer end portion 31a on the mounting portion 31 toward the housing member 10. In one example, the compressible member 40 of the mounting portion 31 includes a compressible spring.

In another example, the mounting portion 31 of the linkage member 30 comprises outer and inner end portions 31a, 31b with the compressible member 40 connected therebetween. For example, the compressible member 40 of the mounting portion 31 can have opposite ends 40a, 40b fixed to the outer and inner end portions 31a, 31b of the mounting portion 31. The outer and inner end portions 31a, 31b of the mounting portion 31 can be each at least partially received in the linkage passage 12 of the housing member 10 in both the engaged position and the released position. During the operation of the removable mounting system 1, the outer and inner end portions 31a, 31b on the mounting portion 31 can retain the compressible member 40 inside the linkage passage 12 in the housing member 10 to restrict the compressible member 40 to move inside the linkage passage 12 in the housing member 10.

In an additional example, the mounting portion 31 of the linkage member 30 can comprise a planar sidewall for contacting a corresponding planar sidewall in the linkage passage 12 of the housing member 10, thereby preventing the mounting portion 31 of the linkage member 30 from rotating inside the linkage passage 12 around the longitudinal direction of the linkage passage 12.

In a further example, the mounting portion 31 of the linkage member 30 and/or the end portion 10b of the housing member 10 can be formed to have a variable length. The variable length of the mounting portion 31 and/or housing member 10 allows the removable mounting system 1 to be mounted in a mounting space of different sizes, as will be described below. For example, the outer end portion 31a of the mounting portion 31 can be formed with a telescoping structure having a threaded connection for continuous adjustability or having discrete connecting points. Various other known or hereafter developed structures, components, and mechanisms herein described or later developed can also be used to achieve the length adjustment.

The removable mounting system 1 can be formed with additional structures, components, and mechanisms to improve the performance of the removable mounting system 1. In one example, the housing member 10 of the removable mounting system 1 can comprise an end cap 42 mounted to the end portion 10b of the housing member 10 opposite from the linkage passage 12. The end cap 42 of the housing member 10 can have a substantially flat end surface 42s. When the removable mounting system 1 is in the engaged position, the substantially flat end surface 42s on the end cap 42 of the housing member 10 can be biased against a structural surface for mounting the removable mounting system 1 to the structure.

In one example, the end cap 42 can be configured to enhance frictional connection between the flat end surface 42s and the structural surface. For example, the flat end surface 42s of the end cap 42 can be made of an elastic material, such as a rubber material. In another example, the flat end surface 42s of the end cap 42 can be made of a magnetic material to be attracted to a metal structural surface when the removable mounting system 1 is mounted thereto. Various other structures, components, and mechanisms can be employed for the same purpose.

Additionally or alternatively, the linkage member 30 of the removable mounting system 1 can comprise an end cap 44 mounted to the outer end portion 31a of the linkage member 30. In one example, the end cap 44 of the linkage member 30 can have a substantially flat end surface 44s. The flat end surface 44a of the end cap 44 can be made of an elastic material. When the removable mounting system 1 is in an engaged position, the substantially flat end surface 44s on the end cap 44 of the linkage member 30 can be biased against a structural surface for mounting the removable mounting system 1 to the structure.

Similar to the end cap 42 of the housing member 10, the end cap 44 of the linkage member 30 can be configured to enhance frictional connection between the flat end surface 44s and the structural surface. For example, the flat end surface 44s of the end cap 44 can be made of an elastic material, such as a rubber material, or a magnetic material. Various other structures, components, and mechanisms can be employed for the same purpose.

To assemble the housing member 10 with the linkage member 30, the linkage member 30 can be inserted in the linkage passage 12 from the end portion 10a of the housing member 10. In one example, part of the interconnecting portion 32 of the linkage member 30 can pass through the linkage passage 12 in the housing member 10 through the longitudinal opening 18 between the longitudinal sidewalls 14a, 14b of the housing member 10.

When the first end 32a of the interconnecting portion 32 reaches the first pivot connection 34, the first end 32a is pivotably connected to the housing member 10, such as through a pivot pin 34p. The mounting portion 31 of the linkage member 30 is received and accommodated in the linkage passage 12 in the housing member 10. As a result, the linkage member 30 is thus interconnected with the housing member 10 to form an assembled removable mounting system 1, as is shown in FIGS. 2 and 3.

In a preferred example, the first end 32a of the interconnecting portion 32 of the linkage member 30 is arranged between portions of the parallel elongated sidewalls 24a, 24b of the elongated structural member 20. The pivot pin 33 pivotably joins the first end 32a of the interconnecting portion 32 to the portions of the parallel elongated sidewalls 24a, 24b of the elongated structural member 20.

The removable mounting system 1 can be formed in various fashions to support various accessory members or components 100. For example, the removable mounting system 1 can further comprise a fastening member for mounting the accessory member or component 100 to the housing member 10. In one example, the accessory member or component 100 is configured as part of a lighting fixture 100. The housing member 10 of the removable mounting system 1 can be configured to mount to a lighting body of the lighting fixture 100. In one example as is shown in FIG. 1, the housing member 10 can be pre-wired and include integrated plugs 60 for connecting to a standard power source. When the removable mounting system 1 is mounted to a structure 110, such as shelves, the lighting body is removably mounted to the structure 110, such as between adjacent shelves of a display structure.

The removable mounting system 1 described above can also be used to removably attach various other accessory members to a structure 110.

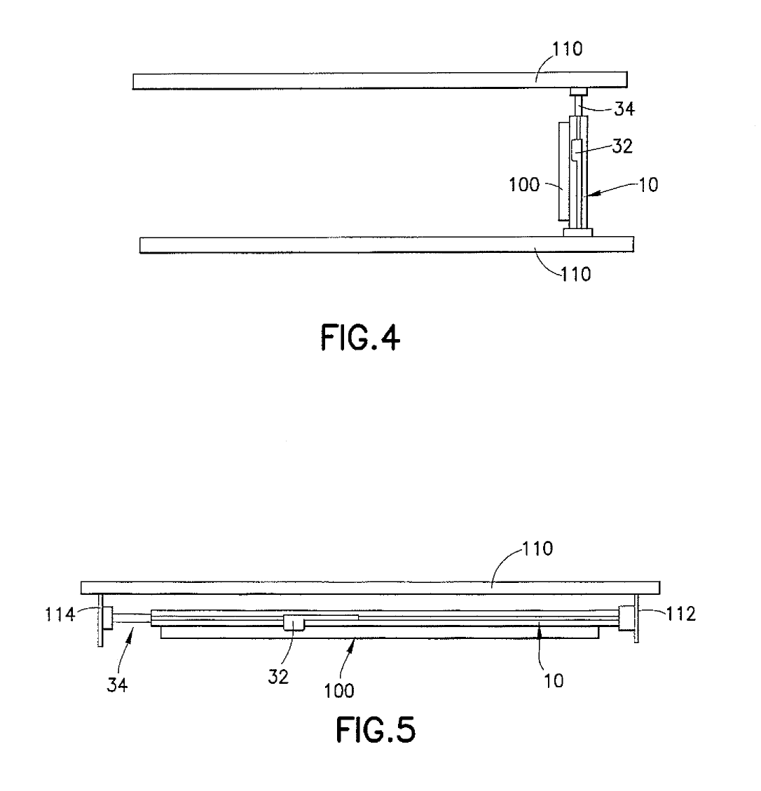

The removable mounting system 1 can be installed between two shelves of the structure 110 as is shown FIG. 4. Before mounting the removable mounting system 1 to a structure 110, the toggle joint 36 can be operated by the user to release the mounting portion 31 of the linkage member 30 to the retracted position. In the example shown in FIG. 2, the released toggle joint 36 causes the outer end portion 31a of the mounting portion 31 to move toward the housing member 10, thereby reduce the length l of the mounting portion 31 extending outside the linkage passage 12 of the housing member 10. As a result, the entire length of the removable mounting system 1 is reduced in the released position.

While maintaining the removable mounting system 1 in its released position, the removable mounting system 1 can be placed in the space between the shelves 110, as is shown in FIG. 4, or removed therefrom. For example, the released removable mounting system 1 can be placed in a space between the shelves 110 at a mounting location determined by the user. Once the removable mounting system 1 reaches its mounting location, the toggle joint 36 of the linkage member 30 can be engaged to extend the outer end portion 31a of the mounting portion 31 away from the housing member 10 increase the length l of the mounting portion 31 extending outside the linkage passage 12 of the housing member 10. As a result, the length of the removable mounting system 1 increases to support the removable mounting system 1 between two mounting surfaces on the structure 110.

In another example where the mounting portion 31 of the linkage member 30 is formed to include a compressible member 38, such compressible member 38 is compressed in the retracted position of the removable mounting system 1. When the compressible member 38 is released in the extended position, the compressible member 38 can additionally bias against the two mounting surfaces on the structure to thereby securely mount the removable mounting system 1 in position.

Additionally or alternatively, the length adjustment mechanism in the mounting portion 31 of the linkage member 30 can be adjusted, as needed during the mounting operation of the removable mounting system 1. As a result, the removable mounting system 1 can be mounted between shelves 110 spaced from each other in various distance.

Alternatively, the removable mounting system 1 can be installed on an upper surface or an under surface of a shelf 110 or other structure, as is shown in FIG. 5. In such an example, the shelf 110 is provided with side supports 112, 114 for holding the removable mounting system 1 therebetween. The mounting operation of the removable mounting system 1 to such the structure 110 of FIG. 5 is understood by one skilled in the art in view of the above description.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A removable mounting system for mounting an accessory component between two support surfaces, the mounting system comprising:
a housing member having an linkage passage extending in a longitudinal direction and opening at an end portion of the housing member, the housing member being configured to be attached to the accessory component; and
a linkage member comprising:
a mounting portion at least partially received in the linkage passage in the housing member and movable in the longitudinal direction of the linkage passage between an extended position and a retracted position, one end of the mounting portion extending out of the open end portion of the housing member; and
a manipulable element connected between the housing member and the mounting portion of the linkage member and movable between an engaged position and a released position;
when the manipulable element is in the engaged position, the mounting portion of the linkage member is in the extended position so that the removable mounting system can be fixed in a mounting position between the two support surfaces; and
when the manipulable element is in the released position, the mounting portion of the linkage member is in the retracted position so that the removable mounting system can be maneuvered into or out of the mounting position.

2. The removable mounting system of claim 1, wherein the mounting portion of the linkage member comprises a planar sidewall for contacting a corresponding planar sidewall in the linkage passage of the housing member to prevent the mounting portion of the linkage member from rotating inside the linkage passage around the longitudinal direction of the linkage passage.

3. The removable mounting system of claim 1, wherein the mounting portion of the linkage member comprises a compressible member operable in the longitudinal direction of the linkage passage of the housing member.

4. The removable mounting system of claim 1,
wherein the mounting portion of the linkage member comprises inner and outer connecting end portions and a compressible member connected between the inner and outer connecting end portions of the linkage member, and
wherein the compressible member is operable in the longitudinal direction of the linkage passage of the housing member.

5. The removable mounting system of claim 4, wherein the inner and outer connecting end portions of the mounting portion are each at least partially received in the linkage passage of the housing member in both the engaged position and the released position.

6. The removable mounting system of claim 1, wherein the compressible member of the mounting portion is a compressible spring having opposite ends fixed to the inner and outer connecting end portions of the mounting portion.

7. The removable mounting system of claim 1,
wherein the housing member comprises longitudinal sidewalls forming the linkage passage, and
wherein the longitudinal sidewalls of the housing member comprise a lateral extension for retaining the mounting portion in the linkage passage and preventing the mounting portion from escaping the linkage passage in a direction transverse to the longitudinal direction.

8. The removable mounting system of claim 1,
wherein the linkage passage in the housing member extends continuously from the open end portion of the housing member to a location where the manipulable element of the linkage member is pivotably mounted to the housing member, and
wherein the linkage member is configured to be received in the linkage passage of the housing member in the engaged position.

9. The removable mounting system of claim 1,
wherein the housing member comprises an elongated structural member extending between to longitudinal ends;
wherein the elongated structural member comprises elongated sidewalls, which enclose an elongated channel extending between the longitudinal ends of the elongated structural member and forming a U-shaped cross section, and
wherein the linkage passage is formed as part of the elongated channel at one of the longitudinal ends.

10. The removable mounting system of claim 9,
wherein the elongated sidewalls of the housing member comprise respective elongated retaining portions facing toward each other in a lateral direction,
wherein the manipulable element is part of a toggle joint with a linkage portion of the toggle joint connecting the manipulable element and the mounting portion of the linkage member, and
wherein the elongated retaining portion is discontinued where the linkage portion of the linkage member is located at the engaged position so that the linkage portion of the linkage member is capable of pivoting between the engaged position and the released position.

11. The removable mounting system of claim 10, wherein at least one of the elongated sidewalls of the housing member is discontinued where the linkage portion of the linkage member is located at the engaged position.

12. The removable mounting system of claim 10, wherein the interconnecting portion of the linkage member is configured to be at least partially received in the elongated channel and between the elongated retaining portions at the engaged position, whereby the elongated retaining portions limit a lateral movement of the interconnecting portion of the linkage member at the engaged position.

13. The removable mounting system of claim 9,
wherein the housing member comprises an end cap mounted to the longitudinal end opposite from the linkage passage, and
wherein the end cap of the housing member has a substantially flat end surface.

14. The removable mounting system of claim 13, wherein the flat end surface of the end cap is made of elastic material.

15. The removable mounting system of claim 1,
wherein the linkage member comprises an end cap mounted to the connecting end portion of the linkage member, and
wherein the end cap of the linkage member has a substantially flat end surface.

16. The removable mounting system of claim 15, wherein the flat end surface of the end cap is made of elastic material.

17. The removable mounting system of claim 1, wherein the linkage member further comprises a projection member configured to assist a user in changing the linkage member between the engaged position and the released position.

18. The removable mounting system of claim 1, further comprising a toggle joint of the linkage member including an interconnecting portion mounted on the housing member and a linkage portion connecting the interconnecting portion and the mounting portion of the linkage member,
wherein the manipulable element comprises one of the interconnecting portion and the mounting portion of the linkage member of the linkage member.

19. The removable mounting system of claim 1, further comprising a fastening member for mounting an accessory member to the housing member.

20. The removable mounting system of claim 1,
wherein the removable mounting system is configured as part of a lighting fixture, and
wherein the housing member is configured to mount to a lighting body of the lighting fixture.
